(19) United States
(12) Patent Application Publication
(10) Pub. No.: US 2010/0230864 A1
(43) Pub. Date: Sep. 16, 2010

(54) Nanoimprint Lithography Template and Method of Fabricating Semiconductor Device Using the Same

(76) Inventors: Chang-min Park, Hwaseong-si (KR); Doo-Hoon Goo, Hwaseong-si (KR); Jeong-Ho Yeo, Suwon-si (KR); Joo-On Park, Suwon-si (KR); In-Sung Kim, Suwon-si (KR); Jeong-Hoon Lee, Yongin-si (KR)

Correspondence Address: F. CHAU & ASSOCIATES, LLC, 130 WOODBURY ROAD, WOODBURY, NY, 11797, US

(21) Appl. No.: 12/719,444

(22) Filed: Mar. 8, 2010

(30) Foreign Application Priority Data
Mar. 13, 2009 (KR) 10-2009-0021716

(51) Int. Cl. B29C 59/16; B29C 59/00

(52) U.S. Cl. 264/447; 264/293; 977/887

(57) ABSTRACT

Nanoimprint lithography templates and methods of fabricating semiconductor devices using the nanoimprint lithography templates are provided. The nanoimprint lithography template includes a transparent substrate having a first refractive index, a stamp pattern on a surface on the transparent substrate and having inclined sidewalls, and a coating layer formed on the inclined sidewalls of the stamp pattern, the coating layer having a second refractive index higher than the first refractive index.

### PRIORITY STATEMENT

This application claims priority under 35 U.S.C. §119 from Korean Patent Application No. 10-2009-0021716, filed on Mar. 13, 2009 in the Korean Intellectual Property Office, the contents of which are herein incorporated reference in their entirety.

### BACKGROUND

1. Field

The present disclosure is directed to a nanoimprint lithography template and methods of fabricating a semiconductor device using the nanoimprint lithography template.

2. Description of Related Art

Next-generation semiconductors will be formed of more minute patterns, and semiconductor process technology will be developed to suit that goal. Forming minute patterns involves techniques for minutely forming a patterning mask for forming the semiconductor patterns. Therefore, various lithography techniques for forming a minute patterning mask have been proposed, including a nanoimprint lithography technique. The nanoimprint lithography technique involves forming a polymer layer on a wafer, and patterning the polymer layer using a nanoimprint lithography template having minute stamp patterns formed therein. More specifically, the polymer layer is physically pressed by the nanoimprint lithography template to form reverse patterns of the stamp patterns on the polymer layer, and either heat or ultraviolet (UV) light is applied to chemically cure the reverse patterns formed on the polymer layer.

### SUMMARY

Exemplary embodiments provide a nanoimprint lithography template which can reduce light attenuation and make uniform the amount of light to be radiated.

Exemplary embodiments provide methods of fabricating a semiconductor device according to a nanoimprint lithography process using a nanoimprint lithography template.

Exemplary embodiments are directed to a nanoimprint lithography template including a transparent substrate having a first refractive index, a stamp pattern on a surface of the transparent substrate and having inclined sidewalls, and a coating layer on the inclined sidewalls of the stamp pattern and having a second refractive index higher than the first refractive index.

Other exemplary embodiments are directed to a nanoimprint lithography template including a quartz substrate having a first refractive index, a stamp pattern on a surface of the quartz substrate and having inclined sidewalls, and a coating layer on the inclined sidewalls of the stamp pattern having a second refractive index higher than the first refractive index, wherein the coating layer comprises, a first unit coating layer in direct contact with the sidewalls having a first refractive index and a second unit coating layer on the first unit coating layer having a second refractive index higher than the first refractive index.

Exemplary embodiments are directed to a method of fabricating a semiconductor device using a nanoimprint lithography template including preparing a semiconductor substrate having a material layer thereon, forming a polymer layer on the material layer, the polymer layer having a first refractive index, pressing a nanoimprint lithography template into the polymer layer to change the polymer layer into a polymer pattern, removing the nanoimprint lithography template to expose the polymer pattern, forming a material pattern by patterning the material layer using the polymer pattern as a patterning mask, and removing the polymer pattern from the material pattern, wherein the nanoimprint lithography template comprises, a transparent template substrate having a second refractive index, a stamp pattern on a surface of the template substrate and having inclined sidewalls, and a coating layer formed on the inclined sidewalls of the stamp pattern having a third refractive index higher than the second refractive index and lower than the first refractive index.

Other exemplary embodiments are directed to a method of fabricating a semiconductor device using a nanoimprint lithography template including preparing a semiconductor substrate having a material layer thereon, forming a polymer layer on the material layer, the polymer layer having a first refractive index, pressing a nanoimprint lithography template into the polymer layer to change the polymer layer into an imprinted polymer pattern, irradiating the imprinted polymer pattern with UV-light to change it into a hardened polymer pattern, removing the nanoimprint lithography template to expose the hardened polymer pattern, forming a material pattern by patterning the material layer using the hardened polymer pattern as a patterning mask, and removing the hardened polymer pattern from the material pattern, wherein the nanoimprint lithography template comprises, a transparent template substrate having a second refractive index lower then the first refractive index, a stamp pattern on a surface of the template substrate and having inclined sidewalls, and a coating layer on the inclined sidewalls of the stamp pattern having a third refractive index higher than the second refractive index and lower then the first refractive index, wherein the coating layer comprises a first unit coating layer in direct contact with the sidewalls of the stamp pattern and a second unit coating layer on the first unit coating layer, and wherein a refractive index of the second unit coating layer is higher than a refractive index of the first unit coating layer.

### BRIEF DESCRIPTION OF THE DRAWINGS

FIG. 1 is a schematic cross-sectional view of a nanoimprint lithography template including a coating layer according to an exemplary embodiment.

FIGS. 2A and 2B illustrate paths of ultraviolet light in processes using nanoimprint lithography templates.

FIG. 3 is a conceptually expanded view of FIG. 2B.

FIGS. 4A and 4B are schematic cross-sectional views of nanoimprint lithography templates according to an application exemplary embodiment.

FIG. 5 is a schematic cross-sectional view of a nanoimprint lithography template according to another application exemplary embodiment.

FIGS. 6 and 7 are schematic cross-sectional views of a nanoimprint lithography template according to still another application exemplary embodiment, conceptually expanding a propagation path of light in a process using a template according to another application exemplary embodiment.

FIGS. 8A through 8E are schematic cross-sectional views illustrating a method of fabricating a semiconductor device using a nanoimprint lithography template according to another application exemplary embodiment.

### DETAILED DESCRIPTION OF EXEMPLARY EMBODIMENTS

Various exemplary embodiments will now be described more fully with reference to the accompanying drawings in which some exemplary embodiments are shown. This inventive concept, however, may be embodied in many alternate forms and should not be construed as limited to exemplary embodiments set forth herein. However, the present inventive concept is not limited to exemplary embodiments described. Like numbers refer to like elements throughout the description of the figures.

A nanoimprint lithography process using ultraviolet (UV) light could be more simply performed within a shorter time than a process using heat, and thus a UV based process might improve productivity. It has been found that stamp patterns formed on a template had a tapered shape and that when the taper angle gradually increases a tilt angle of the sidewalls decreases. When stamp patterns are formed in a tapered shape, the absolute and relative areas of the inclined sidewalls may increase. In this case, light may be attenuated in these portions and not be uniformly irradiated onto an object, resulting in undesirable patterns being formed.

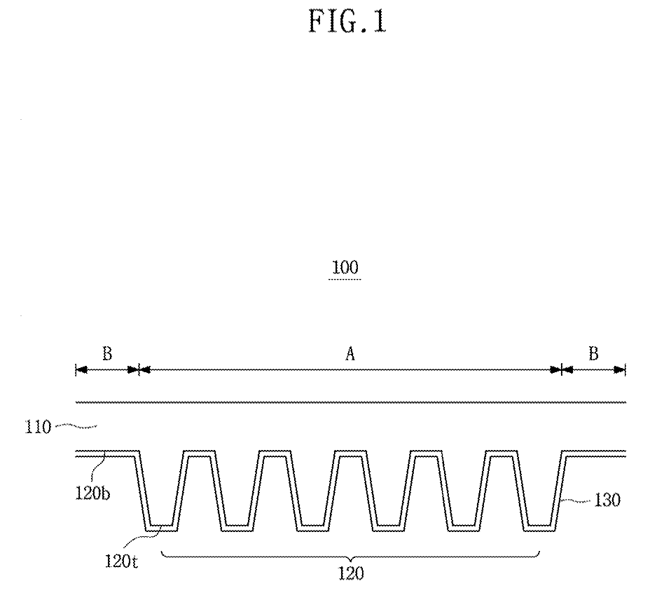

FIG. 1 is a schematic cross-sectional view of a nanoimprint lithography template including a coating layer according to an embodiment of the general inventive concept. Referring to FIG. 1, a nanoimprint lithography template 100 includes a template substrate 110, a stamp pattern 120 formed on one surface of the template substrate 110, and a coating layer 130 formed on the stamp pattern 120.

The template substrate 110 may be formed of an inorganic material transparent to ultraviolet light. For example, the template substrate 110 may be formed of quartz. In nanoimprint lithography technology, the stamp pattern 120 formed on the template substrate 110 may have the same size as a pattern formed on a wafer. The template substrate 110 may include a pattern region A and a peripheral region B. The pattern region A may be positioned at the central portion of the template substrate 110. The peripheral region B may be positioned outside the pattern region A to surround the pattern region A of the template substrate 110.

The stamp pattern 120 may be formed in the pattern region A. The stamp pattern 120 may be formed to have an uneven (rugged or jagged) shape in a predetermined region of the template substrate 110. The stamp pattern 120 may be formed in a tapered shape. In other words, sidewalls thereof may be inclined. The stamp pattern 120 may have flat bottom and top surfaces 120b and 120t. The inclined angle with respect to the bottom and top surfaces may be more than about 45 degrees and less than about 90 degrees.

The coating layer 130 may have a higher refractive index than the template substrate 110. For example, when the template substrate 110 is formed of quartz, the template substrate 110 has a refractive index of about 1.5, and the coating layer 130 may have a refractive index of 1.6, higher than that of the template substrate 110. When the refractive index of the coating layer 130 is higher than that of the template substrate 110, total reflection may be prevented at the interface therebetween.

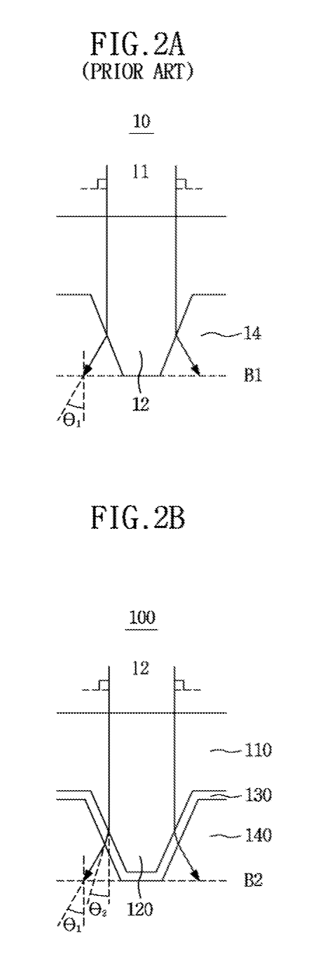

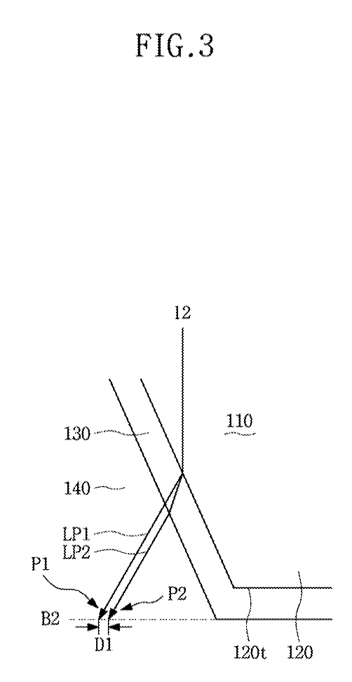

FIGS. 2A and 2B illustrate paths of ultraviolet light in a process using a nanoimprint lithography template. FIG. 3 is a conceptually enlarged view of FIG. 2B. FIG. 2A illustrates a virtual path of light l1 in a template substrate 10 having a polymer layer 14 but no coating layer, and FIG. 2B illustrates a virtual path of light l2 in the template 100 having the coating layer 130. In this exemplary embodiment, polymer layers 14 and 140 have the highest refractive index, and the template substrates 10 and 110 have the lowest refractive index.

Referring to FIG. 2A, when the light l1 incident on the template substrate 10 at right angles passes through an interface between the stamp pattern 12 and the polymer layer 14, the path of the light l1 changes by an angle θ1. Then, the light l1 is incident on a bottom surface B1 of the polymer layer 14. The path of the light l1 changes because the template substrate 10 has a different refractive index from the polymer layer 14. FIG. 2A illustrates a case in which the refractive index of the polymer layer 14 is higher than that of the template substrate 10. The angle θ1 is an arbitrary angle which changes depending on the relative refractive indices of the materials.

Referring to FIG. 2B, when light l2, incident on the template substrate 110 at right angles, passes through an interface between the stamp pattern 120 and the coating layer 130, the path of the light l2 changes by an angle θ2. Further, when the light l2 passes through an interface between the coating layer 130 and the polymer layer 140, the path of the light l2 changes by the angle θ1. Then, the light l2 is incident upon a bottom surface B2 of the polymer layer 140. The angle θ2 is smaller than the angle θ1.

In FIG. 2B, it is assumed that the refractive index of the polymer layer 140 is higher than that of the template substrate 110. The refractive index of the polymer layer 140 may be lower than that of the template substrate 110. When light propagates from a medium having a higher refractive index into a medium having a lower refractive index, the light may be totally reflected at the interface therebetween. That is, when the refractive index of the template substrate 110 is higher than that of the polymer layer 140, it is highly likely that the light l1 will be totally reflected at the interface between the template substrate 10 and the polymer layer 14 in the process illustrated in FIG. 2A. However, the existence of the coating layer 130 may prevent the total reflection from occurring in the middle, even when the refractive index of the polymer layer 140 is lower than that of the template substrate 110. This will be understood with reference to the descriptions of other various exemplary embodiments.

Referring to FIG. 2B, when the refractive index of the polymer layer 140 is much higher than that of the template substrate 110, total reflection does not occur, but light attenuation increases. Even in this case, the existence of the coating layer 130 can prevent total reflection from occurring, and simultaneously reduce attenuation of light. This will also be understood with reference to the descriptions of other various exemplary embodiments. The polymer layer 140 may be formed of organic or inorganic materials.

In FIG. 3, a light path LP1 indicates a case in which the coating layer is not formed, and a light path LP2 indicates a case in which the coating layer is formed. As shown in FIG. 3, the light path LP1 is different from the light path LP2. Further, positions P1 and P2 on the bottom surface B2 of the polymer layer 140, onto which the light is incident along the light paths LP1 and LP2, respectively, are spaced a distance D1 apart from each other. When there is no coating layer 130 formed on the surface of the stamp pattern 120, the light incident on the template substrate 110 at right angles passes through the interface between the stamp pattern 120 and the polymer layer 140, which changes the path of the light by the angle θ1. Then, the light is incident upon the first position P1 of the bottom surface B2 of the polymer layer 140. When there is a coating layer 130 formed on the stamp pattern 120, the light l2 incident on the template substrate 110 at right angles passes through the interface between the stamp pattern 120 and the coating layer 130, which changes the path of the light l2 by the angle θ2. Further, when the light l2 passes through the interface between the coating layer 130 and the polymer layer 140, the path of the light l2 changes by the angle θ1. Then, the light l2 is incident upon the position P2 of the bottom surface B2 of the polymer layer 140. The angles θ1 and θ2 and the distance D1 between the positions P1 and P2 may change depending on the taper angles of the stamp patterns 120, the type and thickness of the coating layer 130, and the type of the polymer layer 140.

When the coating layer 130 is formed, the position P2 on the bottom surface B2 of the polymer layer 140, onto which the light l2 is incident, shifts a distance D1 toward the interface of the coating layer 130 and the polymer layer 140. This shift of the light path LP2 can compensate for a lower intensity of light l2 incident onto the bottom surface B2 of the polymer layer 140.

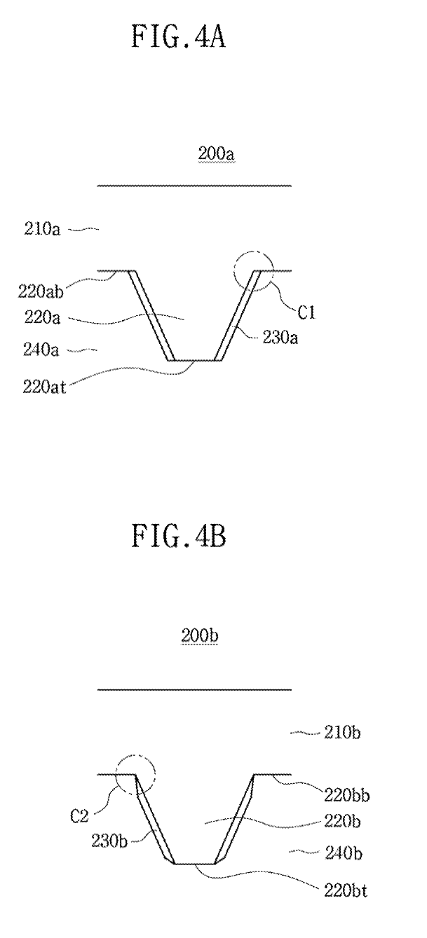

FIGS. 4A and 4B are simple vertical sectional views of nanoimprint lithography templates according to application exemplary embodiments. Referring to FIGS. 4A and 4B, nanoimprint lithography templates 200a and 200b according to application exemplary embodiments include template substrates 210a and 210b, stamp patterns 220a and 220b formed on one surface of the templates substrate 210a and 210b, and coating layers 230a and 230b formed on the stamp patterns 220a and 220b, respectively. The coating layers 230a and 230b are formed on sidewalls of the stamp patterns 220a and 220b, respectively.

When light passing through the template substrates 210a and 210b onto the polymer layers 240a and 240b is incident on the inclined surfaces of the stamp patterns 220a and 220b, the light intensity may be attenuated by reflection or diffraction. At the horizontal surfaces of the stamp patterns 220a and 220b, that is, the bottom surfaces 220ab and 220bb or the top surfaces 220 at and 220bt of the stamp patterns 220a and 220b, the light intensity may not be substantially attenuated. As shown in FIG. 4A, a corner C1 of the bottom surface 220ab of the stamp pattern 220a may be covered by the coating layer 230a. As shown in FIG. 4B, a corner C2 of the bottom surface 220bb of the stamp pattern 220b may not be covered by the coating layer 230b, but rather be exposed. Further, when the coating layer 230b is formed on the sidewalls of the stamp pattern 220b, the coating layer 230b may be formed at a steeper angle in the corner C2 of the stamp pattern 220b.

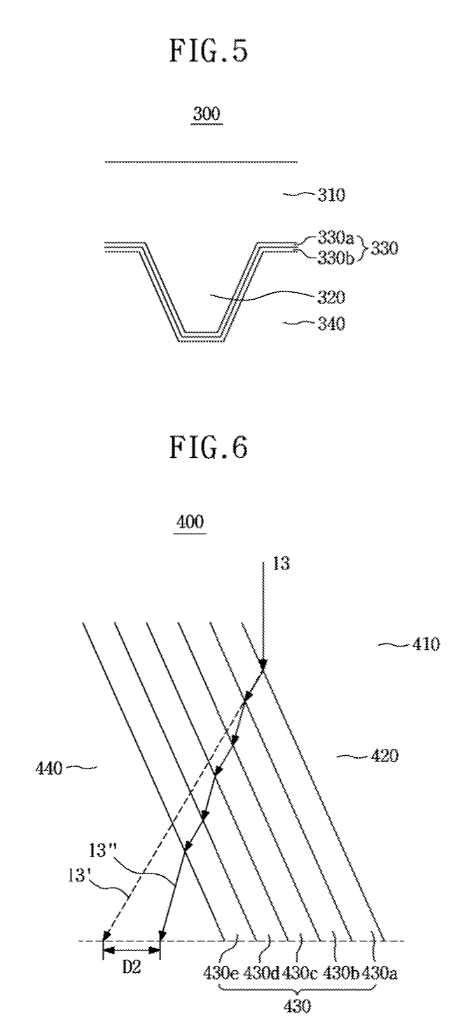

FIG. 5 is a schematic cross-sectional view of a nanoimprint lithography template according to another application exemplary embodiment of the general inventive concept. FIG. 5 illustrates a case in which two unit coating layers are formed. Referring to FIG. 5, a nanoimprint lithography template 300 includes a template substrate 310, a stamp pattern 320 formed on one surface of the template substrate 310, and a coating layer 330 formed on the stamp pattern 320 and composed of multiple layers. The coating layer 330 includes multiple unit layers which may be formed of materials having various refractive indices. For example, the coating layer 330 may include a material layer having a lower refractive index than the template substrate 310. Referring to FIGS. 1 to 4, when the coating layers 130 and 230 are formed in a single layer structure and have a lower refractive index than the template substrates 110 and 210, total reflection may occur at the interface therebetween. The likelihood of total reflection increases as the taper angle of the stamp patterns 120 and 220 approaches a right angle to the template substrates 110 and 210. Therefore, when the coating layers 130 and 230 are formed in a single layer structure, there is a range of incidence angles for which light attenuation occurring between the stamp patterns 120 and 220 and the polymer layers 140 and 240 cannot be compensated. In this case, when the coating layer 340 is formed of multiple layers, this range of incidence angles may be reduced. The respective unit coating layers 330a and 320b of the coating layer 330 may be formed of various materials having differing refractive indices. In this application exemplary embodiment, the unit coating layer 330a which is directly formed on the template substrate 310 may have a higher refractive index than the template substrate 310.

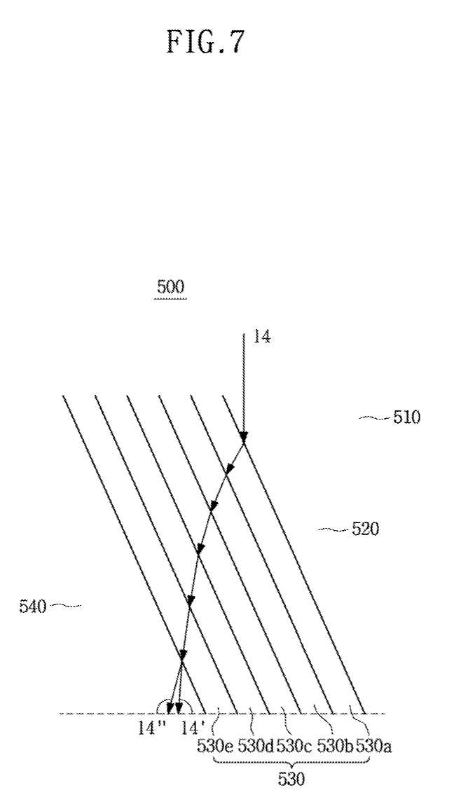

FIG. 6 is a vertical sectional view of a nanoimprint lithography template according to still another application exemplary embodiment, conceptually expanding a light propagation path using the template. FIG. 6 illustrates a case in which a coating layer is formed of three or more unit coating layers. Referring to FIG. 6, a nanoimprint lithography template 400 according to this application exemplary embodiment includes a template substrate 410, a stamp pattern 420 formed on one surface of the template substrate 410, and a coating layer 430 formed on the stamp pattern 420 and composed of multiple layers. Although five unit layers 430a to 430e are depicted, this number is exemplary and non-limiting, and a coating layer 430 may have more or fewer unit coating layers. The multiple unit layers forming coating layer 430 may be formed of materials having various refractive indices. In particular, some or all of unit coating layers 430a to 430e may have a higher refractive index than the template substrate 410. On the other hand, the unit coating layers 430a to 430e may have a lower refractive index than the template substrate 410.

Referring to FIG. 6, when the nanoimprint lithography template 400 according to this application exemplary embodiment is used to perform a process, light l3 that has passed through the template substrate 410 passes through the coating layer 430 formed of multiple layers. Upon passing through the coating layer 430, the propagation path of the light l3 changes at each interface between the respective unit coating layers 430a to 430e. More specifically, depending on the relative refractive indices of the respective unit coating layers 430a to 430e, the path of the light l3 may change by acute or obtuse angles at the interfaces therebetween. If the unit coating layers 430a to 430e in direct contact have the same refractive index, the propagation angle of the light l3 will remain unchanged. That is, the light l3 will propagate in a straight line. When the refractive index of a next layer is lower than that of a previous layer through which the light l3 has propagated, the propagation direction of the light l3 will change by an acute angle. On the other hand, when the refractive index of a next layer is higher than that of a previous layer through which the light l3 has propagated, the propagation direction of the light l3 will change by an obtuse angle. FIG. 6 illustrates changes in the propagation direction of the light l3. In addition, when the coating layer 430 is formed of multiple layers, a position onto which the light l3″ is incident can shift a distance D2 toward the stamp pattern 420. That is, the coating layer 430 formed of multiple layers can compensate for attenuation of the light l3′, because a coating layer formed of multiple layers may include a material layer having a higher refractive index than the template substrate 410. Further, the angle of light incident onto the polymer layer 440 may vary depending on the combinations of the unit coating layers 430a to 430e.

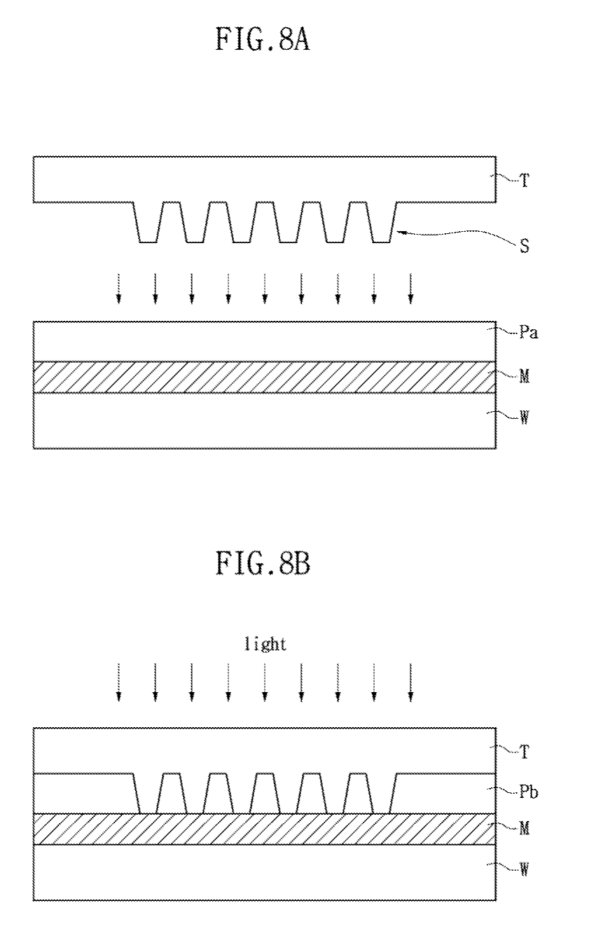

FIG. 7 is a vertical sectional view of a nanoimprint lithography template according to still another application exemplary embodiment, conceptually expanding a light propagation path using the template. FIG. 7 illustrates a nanoimprint lithography template 500, a stamp pattern 520 formed on one surface of the template substrate 510, in a case in which a coating layer 530 is formed of material layers in which the refractive indices sequentially decrease, so that the propagation path of light l4 gradually shifts in one direction, as indicated by comparing the path of light l4″ in the polymer layer 540 to that of light l4′. The refractive indices of unit coating layers 530a to 530e in contact with the template substrate 510 may be higher than that of the template substrate 510, and may sequentially decrease. Again, although five unit layers 530a to 530e are depicted, this number is exemplary and non-limiting, and a coating layer 530 may have more or fewer unit coating layers.

Table 1 shows the refractive indices of film materials which can be used in a multiple layer coating layer according to exemplary embodiments. Since the refractive indices of the respective materials may differ depending on the degree of purity of the respective materials or on added materials, the refractive indices of the materials shown in Table 1 should be used primarily for reference. If the taper angle of the stamp patterns and the wavelength of the light to be used in a process are known, and a coating layer is formed of one material layer or various material layers, it is possible to successfully perform a nanoimprint lithography process.

TABLE 1

| Material | Refractive index | Material | Refractive index |
|---|---|---|---|
| Na₃AlF₆ | 1.33 | Poly vinyl chlorite | 1.54-1.55 |
| CaF₂ | 1.35 | SiO₂ | 1.55 |
| Teflon | 1.35-1.38 | Polyurethane | 1.59 |
| MgF₂ | 1.38 | Urethane | 1.5-1.6 |
| BaF₂ | 1.4 | Epoxy | 1.55-1.60 |
| Silica glass | 1.458 | Al₂O₃ | 1.63 |
| Cellulose | 1.46-1.50 | CeF₃ | 1.63 |
| Borosilicate | 1.47 | Mullite | 1.64 |
| | | (Al₂O₃•SiO₂) | |
| Polypropylene | 1.47 | TiN | 1.68 |
| Phenol resin | 1.47-1.50 | Spitel | 1.72 |
| | | (MgO•Al₂O₃) | |
| Glass made of albite | 1.49 | MgO | 1.74 |
| Glass made of orthoclase | 1.51 | Corundum | 1.76 |
| Low-density polyethylene | 1.51 | Sapphire | 1.77 |
| Soda-lime-silica glass | 1.51-1.52 | High-density glass | 1.89 |
| Crude rubber | 1.52 | HfO₂ | 2.0 |
| Orthoclase (KAlSi₃O₈) | 1.525 | ITO | 2.0 |
| Albite (NaAlSi₃O₈) | 1.529 | ZrO₂ | 2.05 |
| Polyimide (nylon 66) | 1.53 | Ta₂O₅ | 2.1 |
| High-density polyethylene | 1.545 | TiO₂ | 2.3 |

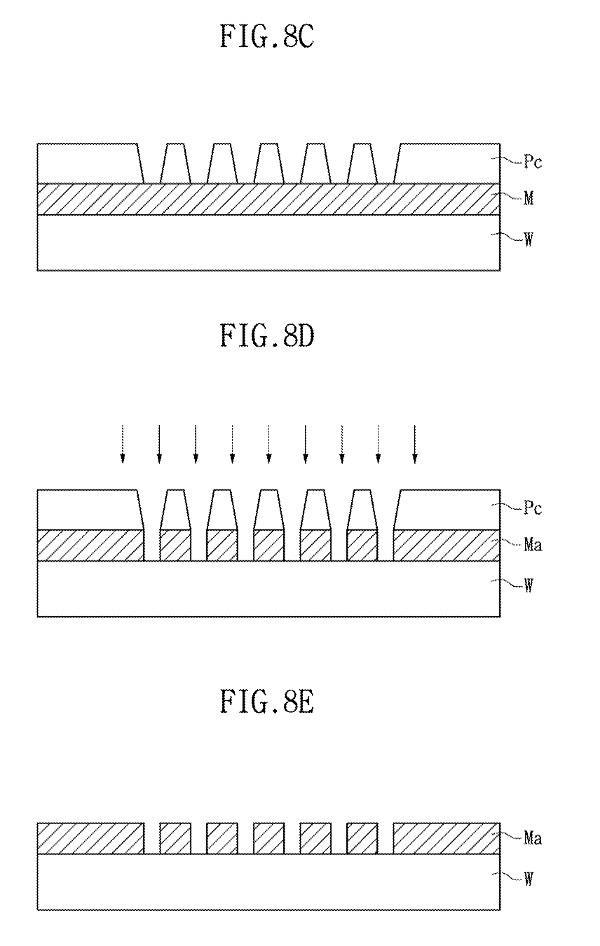

FIGS. 8A to 8E are schematic cross-sectional views illustrating a method of fabricating a semiconductor device using a template according to embodiments of the general inventive concept. Specifically, one step of a nanoimprint lithography process using a nanoimprint lithography template is described. Referring to FIG. 8A, a semiconductor substrate W and a nanoimprint lithography template T according to an embodiment of the general inventive concept are prepared. The semiconductor substrate W includes a material layer M to be patterned thereon and a polymer layer Pa on the material layer M. The nanoimprint lithography template T includes a stamp pattern S on the surface.

Referring to FIG. 8B, the nanoimprint lithography template T is pressed into the polymer layer Pa of the semiconductor substrate W. The stamp pattern S is pressed into the polymer layer Pa which changes into an imprinted polymer pattern Pb. Then, UV-light may be irradiated onto the imprinted polymer pattern Pb through the nanoimprint lithography template.

Referring to FIG. 8C, the imprinted polymer pattern Pb may be hardened by the light and changed into a hardened polymer pattern Pc. Then, the nanoimprint lithography template T may be removed.

Referring to FIG. 8D, the material layer M may be patterned using the hardened polymer pattern Pc as a patterning mask. The patterning process may be an etching process of a semiconductor fabricating process.

Referring to FIG. 8E, the hardened polymer pattern Pc may be removed and a material pattern Ma may be formed on the semiconductor substrate W. Here, one step of a nanoimprint lithography process using the nanoimprint lithography template T is completed.

When the above-described nanoimprint lithography template according to exemplary embodiments is used, light attenuation decreases and irradiation uniformity improves, rendering possible more stably formed patterns.

The foregoing is illustrative of exemplary embodiments of the general inventive concept and is not to be construed as limiting thereof. Although a few exemplary embodiments have been described, those skilled in the art will readily appreciate that many modifications are possible in other exemplary embodiments without materially departing from the novel teachings. Accordingly, all such modifications are intended to be included within the scope of this inventive concept as defined in the claims. Therefore, it is to be understood that the foregoing is illustrative of various exemplary embodiments and is not to be construed as limited to the specific embodiments disclosed, and that modifications to the disclosed embodiments, as well as other embodiments, are intended to be included within the scope of the appended claims.

What is claimed is:

1. A method of fabricating a semiconductor device using a nanoimprint lithography template, comprising:
preparing a semiconductor substrate having a material layer thereon;
forming a polymer layer on the material layer, said polymer layer having a first refractive index;
pressing a nanoimprint lithography template into the polymer layer to change the polymer layer into a polymer pattern;
removing the nanoimprint lithography template to expose the polymer pattern;
forming a material pattern by patterning the material layer using the polymer pattern as a patterning mask; and
removing the polymer pattern from the material pattern,
wherein the nanoimprint lithography template comprises:
a transparent template substrate having second refractive index and lower than the first refractive index;
a stamp pattern on a surface of the template substrate and having inclined sidewalls; and
a coating layer on the inclined sidewalls of the stamp pattern, said coating layer having a third refractive index higher than the second refractive index and lower than the first refractive index.

2. The method according to claim 1, further comprising, radiating light through the nanoimprint lithography template to the polymer layer.

3. The method according to claim 1, wherein the coating layer comprises a first unit coating layer in direct contact with the sidewalls of the stamp pattern and a second unit coating layer on the first unit coating layer.

4. The method according to claim 3, wherein the first unit coating layer has a fourth refractive index and the second unit coating layer has a fifth refractive index, and wherein the fourth and fifth refractive indices are different from each other.

5. The method according to claim 4, wherein the fifth refractive index is higher than the fourth refractive index.

6. The method according to claim 3, wherein the first unit coating layer has a higher refractive index than the refractive index of the template substrate.

7. The method according to claim 3, wherein one of the unit coating layers is formed on both the sidewalls and bottoms of the stamp pattern, and another one of the unit coating layers is formed only on the sidewalls of the stamp pattern.

8. The method according to claim 1, wherein an angle of the inclined sidewalls with respect to a bottom surface of the stamp pattern is from about 50 degrees to about 85 degrees

9. A method of fabricating a semiconductor device using a nanoimprint lithography template, comprising:
preparing a semiconductor substrate having a material layer thereon,
forming a polymer layer on the material layer, said polymer layer having a first refractive index;
pressing a nanoimprint lithography template into the polymer layer to change the polymer layer into an imprinted polymer pattern;
radiating UV-light onto the imprinted polymer pattern to change it into a hardened polymer pattern;
removing the nanoimprint lithography template to expose the hardened polymer pattern;
forming a material pattern by patterning the material layer using the hardened polymer pattern as a patterning mask; and
removing the hardened polymer pattern from the material pattern,
wherein the nanoimprint lithography template comprises,
a transparent template substrate having a second refractive index lower than the first refractive index;
a stamp pattern on a surface on the template substrate and having inclined sidewalls; and
a coating layer formed on the inclined sidewalls of the stamp pattern, said coating layer having a third refractive index higher than the second refractive index and lower than the first refractive index,
wherein the coating layer comprises a first unit coating layer in direct contact with the sidewalls of the stamp pattern and a second unit coating layer on the first unit coating layer, and
wherein a refractive index of the second coating layer is higher than a refractive index of the first coating layer.
